(19) United States
(12) Patent Application Publication
(10) Pub. No.: US 2015/0098475 A1
(43) Pub. Date: Apr. 9, 2015

(54) HOST TABLE MANAGEMENT IN SOFTWARE DEFINED NETWORK (SDN) SWITCH CLUSTERS HAVING LAYER-3 DISTRIBUTED ROUTER FUNCTIONALITY

(71) Applicant: International Business Machines Corporation, Armonk, NY (US)

(72) Inventors: Sriharsha Jayanarayana, Bangalore (IN); Dayavanti G. Kamath, Santa Clara, CA (US); Abhijit P. Kumbhare, San Jose, CA (US); Anees A. Shaikh, Yorktown Heights, NY (US)

(73) Assignee: International Business Machines Corporation, Armonk, NY (US)

(21) Appl. No.: 14/050,288

(22) Filed: Oct. 9, 2013

(51) Int. Cl. H04L 12/747

(52) U.S. Cl. CPC H04L 45/742
USPC 370/400

(57) ABSTRACT

According to one embodiment, a system includes a switch controller in communication with a plurality of switches in a switch cluster via a communication protocol, at least one switch in the switch cluster being configured to connect to a host, wherein the switch controller is configured to: maintain a Layer-3 (L3) host table configured to store entries including address information for hosts connected directly to the switch cluster, apply a policy to all existing entries in the L3 host table, and remove one or more existing entries according to the policy in order to reduce a number of entries in the L3 host table. In other embodiments, systems, computer program products, and methods for managing a L3 host table in software defined network (SDN)-based switch clusters having L3 distributed router functionality are presented.

### BACKGROUND

The present invention relates to data center infrastructure, and more particularly, this invention relates to host table management in software defined network (SDN)-based switch clusters having Layer-3 distributed router functionality.

A common practice for SDN controllers is to use the OpenFlow protocol to create a logical OpenFlow domain or a switch cluster comprising a plurality of switches therein. However, any other protocol may be used to create these switch clusters. The switch cluster does not exist in a vacuum and communication with entities outside of the switch cluster is needed in order to function in a real application. This communication typically takes place with non-SDN Layer-2/Layer-3 (L2/L3) devices and networks.

L2 communications with a non-SDN device is typically handled in any commercially available SDN controller, such as an OpenFlow controller utilizing Floodlight. However, conventional SDN controllers are not capable of handling L3 communications.

One prior attempt to provide L3 communications to a switch cluster is virtual router support in NEC's Programmable Flow Controller; however, it relies on a ternary content-addressable memory (TCAM)-based OpenFlow Table alone, which in most switches has a significantly lower number of flow table entries and hence does not scale effectively to be used in switch clusters.

Accordingly, it would be beneficial to provide a mechanism to provide L3 support for a SDN-based switch cluster in a scalable fashion. Existing conventional methods to accomplish L3 communications rely on OpenFlow 1.0 style TCAM tables, also known as access control list (ACL) tables, alone, which are expensive to implement and typically have a much lower number of total entries.

### SUMMARY

According to one embodiment, a system includes a switch controller in communication with a plurality of switches in a switch cluster via a communication protocol, at least one switch in the switch cluster being configured to connect to a host, wherein the switch controller is configured to: maintain a Layer-3 (L3) host table configured to store entries including address information for hosts connected directly to the switch cluster, apply a policy to all existing entries in the L3 host table, and remove one or more existing entries according to the policy in order to reduce a number of entries in the L3 host table.

In another embodiment, a system includes a switch, the switch being a member of a switch cluster which includes a plurality of switches, wherein the switch is configured to: communicate with a switch controller via a communication protocol, directly connect to one or more hosts external of the switch cluster, maintain a L3 host table configured to store entries including address information for the hosts connected directly to the switch, apply a policy to all existing entries in the L3 host table to determine whether any existing entries fail one or more predetermined criteria, and remove one or more existing entries according to the policy in order to reduce a number of entries in the L3 host table.

In yet another embodiment, a method for managing a L3 host table includes applying a policy to all existing entries in a L3 host table to determine whether any existing entries fail one or more predetermined criteria of the policy, the L3 host table being configured to store entries including address information for hosts connected directly to a switch cluster, the switch cluster including a plurality of switches capable of communicating with a switch controller, and removing one or more existing entries according to the policy in order to reduce a number of entries in the L3 host table.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 is a simplified diagram of a virtualized data center, according to one embodiment.

FIG. 4 is a simplified topological diagram of a software defined network (SDN) switch cluster operating as a distributed router, according to one embodiment.

FIG. 5 is a flowchart of a method, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified.

In order to determine a port with which to forward traffic received at a switch in a software defined network (SDN)-based switch cluster, an access control list (ACL) or ternary content-addressable memory (TCAM)-based Table for Layer-3 (L3) switch cluster support may be used. However, due to the limited number of entries available in such tables, it is difficult to scale these tables to include a large number of entries. Accordingly, L3 Forwarding Tables may be used, according to one embodiment, which usually have much higher capacity (measured in number of entries) and provide for the possibility to scale better than ACL or TCAM-based Tables.

Each switch in a switch cluster comprises a L3 Forwarding Table, also known as a Route Table or a Longest Prefix Match Table (LPM), and a Host Table or address resolution protocol (ARP) Table, which expose L3 Forwarding Tables to a SDN controller, via SDN communication protocols (such as OpenFlow), while retaining the possibility to use TCAM-based Tables in any switches which are not SDN-capable (and/or not involved in the switch cluster) for access to L3 Forwarding Tables.

L3 Forwarding Tables typically have more entries than the more expensive TCAM-based SDN Table (e.g., IBM's G8264 which has 750 TCAM entries as compared to 16,000+ LPM routes).

Conventional switch clusters rely on a SDN controller to initialize and manage the switches in the switch cluster. Any suitable SDN controller may be used, such as an OpenFlow controller, Floodlight, NEC's Programmable Flow Controller (PFC), IBM's Programmable Network Controller (PNC), etc.

According to one embodiment, using this SDN controller, each switch cluster may be L3-aware and may support L3 subnets and forwarding as a single entity. Different types of switch clusters may be used in the methods described herein, including traditional OpenFlow clusters (like Floodlight, NEC PFC, IBM PNC), and SPARTA clusters using IBM's Scalable Per Address RouTing Architecture (SPARTA). According to another embodiment, each switch cluster acts as one virtual L3 router with virtual local area network (VLAN)-based internet protocol (IP) interfaces—referred to herein as a distributed router approach.

According to one general embodiment, a system includes a switch controller in communication with a plurality of switches in a switch cluster via a communication protocol, at least one switch in the switch cluster being configured to connect to a host, wherein the switch controller is configured to: maintain a Layer-3 (L3) host table configured to store entries including address information for hosts connected directly to the switch cluster, apply a policy to all existing entries in the L3 host table, and remove one or more existing entries according to the policy in order to reduce a number of entries in the L3 host table.

In another general embodiment, a system includes a switch, the switch being a member of a switch cluster which includes a plurality of switches, wherein the switch is configured to: communicate with a switch controller via a communication protocol, directly connect to one or more hosts external of the switch cluster, maintain a L3 host table configured to store entries including address information for the hosts connected directly to the switch, apply a policy to all existing entries in the L3 host table to determine whether any existing entries fail one or more predetermined criteria, and remove one or more existing entries according to the policy in order to reduce a number of entries in the L3 host table.

In yet another general embodiment, a method for managing a L3 host table includes applying a policy to all existing entries in a L3 host table to determine whether any existing entries fail one or more predetermined criteria of the policy, the L3 host table being configured to store entries including address information for hosts connected directly to a switch cluster, the switch cluster including a plurality of switches capable of communicating with a switch controller, and removing one or more existing entries according to the policy in order to reduce a number of entries in the L3 host table.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), a Blu-Ray disc read-only memory (BD-ROM), an optical storage device, a magnetic storage device, or any suitable combination of the foregoing. In the context of this document, a non-transitory computer readable storage medium may be any tangible medium that is capable of containing, or storing a program or application for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device, such as an electrical connection having one or more wires, an optical fiber, etc.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN), storage area network (SAN), and/or a wide area network (WAN), any virtual networks, or the connection may be made to an external computer, for example through the Internet using an Internet Service Provider (ISP).

Aspects of the present invention are described herein with reference to flowchart illustrations and/or block diagrams of methods, apparatuses (systems), and computer program products according to various embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

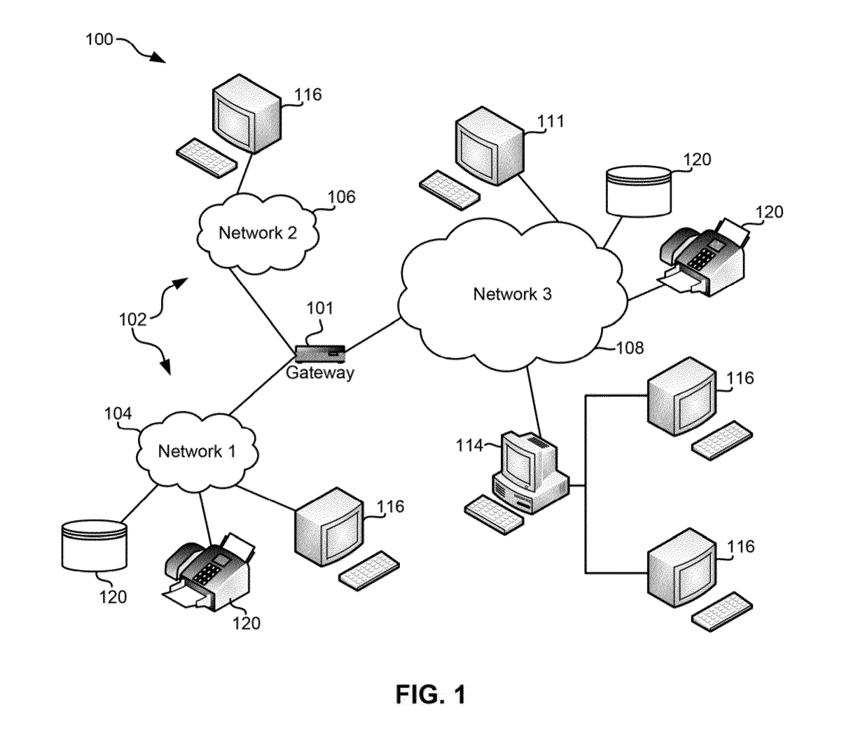

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a VLAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, handheld computer, printer, and/or any other type of logic-containing device. It should be noted that a user device 111 may also be directly coupled to any of the networks, in some embodiments.

A peripheral 120 or series of peripherals 120, e.g., facsimile machines, printers, scanners, hard disk drives, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used, as known in the art.

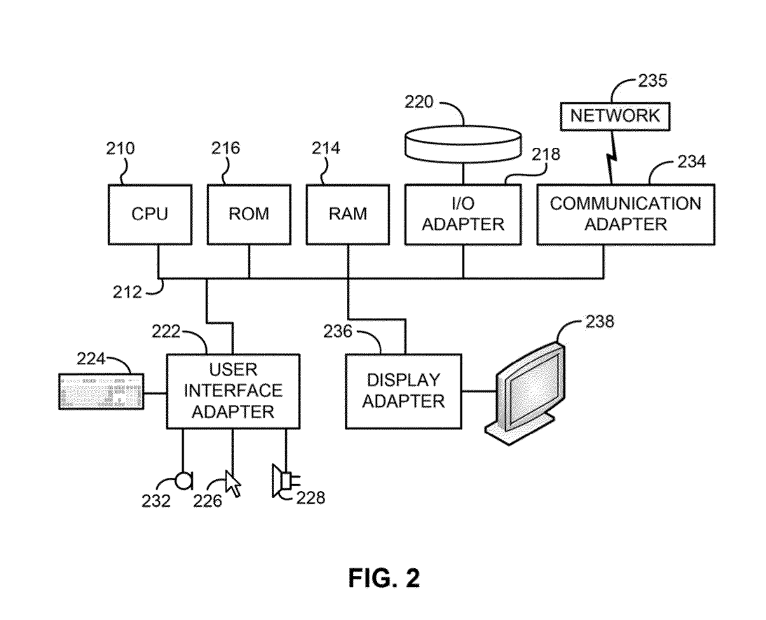

FIG. 2 shows a representative hardware environment associated with a user device 116 and/or server 114 of FIG. 1, in accordance with one embodiment. FIG. 2 illustrates a typical hardware configuration of a workstation having a central processing unit (CPU) 210, such as a microprocessor, and a number of other units interconnected via one or more buses 212 which may be of different types, such as a local bus, a parallel bus, a serial bus, etc., according to several embodiments.

The workstation shown in FIG. 2 includes a Random Access Memory (RAM) 214, Read Only Memory (ROM) 216, an I/O adapter 218 for connecting peripheral devices such as disk storage units 220 to the one or more buses 212, a user interface adapter 222 for connecting a keyboard 224, a mouse 226, a speaker 228, a microphone 232, and/or other user interface devices such as a touch screen, a digital camera (not shown), etc., to the one or more buses 212, communication adapter 234 for connecting the workstation to a communication network 235 (e.g., a data processing network) and a display adapter 236 for connecting the one or more buses 212 to a display device 238.

The workstation may have resident thereon an operating system such as the MICROSOFT WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

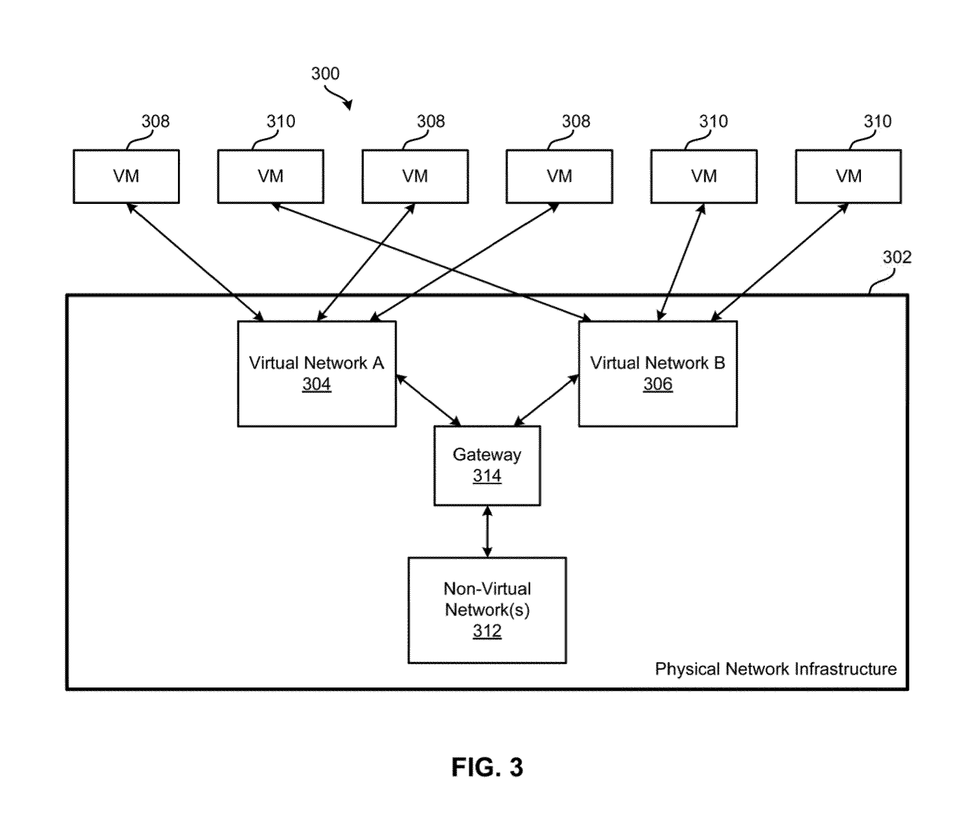

Referring now to FIG. 3, a conceptual view of an overlay network 300 is shown according to one embodiment. The overlay network may utilize any overlay technology, standard, or protocol, such as a Virtual eXtensible Local Area Network (VXLAN), Distributed Overlay Virtual Ethernet (DOVE), Network Virtualization using Generic Routing Encapsulation (NVGRE), etc.

In order to virtualize network services, other than simply providing a fabric communication path (connectivity) between devices, services may be rendered on packets as they move through the gateway 314 which provides routing and forwarding for packets moving between the non-virtual network(s) 312 and the Virtual Network A 304 and Virtual Network B 306. The one or more virtual networks 304, 306 exist within a physical (real) network infrastructure 302. The network infrastructure 302 may include any components, hardware, software, and/or functionality typically associated with and/or used in a network infrastructure, including, but not limited to, switches, connectors, wires, circuits, cables, servers, hosts, storage media, operating systems, applications, ports, I/O, etc., as would be known by one of skill in the art. This network infrastructure 302 supports at least one non-virtual network 312, which may be a legacy network.

Each virtual network 304, 306 may use any number of virtual machines (VMs) 308, 310. In one embodiment, Virtual Network A 304 includes one or more VMs 308, and Virtual Network B 306 includes one or more VMs 310. As shown in FIG. 3, the VMs 308, 310 are not shared by the virtual networks 304, 306, but instead are exclusively included in only one virtual network 304, 306 at any given time.

According to one embodiment, the overlay network 300 may include one or more cell switched domain scalable fabric components (SFCs) interconnected with one or more distributed line cards (DLCs).

By having a “flat switch” architecture, the plurality of VMs may move data across the architecture easily and efficiently. It is very difficult for VMs, generally, to move across Layer-3 (L3) domains, between one subnet to another subnet, internet protocol (IP) subnet to IP subnet, etc. But if it the architecture is similar to a large flat switch, in a very large Layer-2 (L2) domain, then the VMs are aided in their attempt to move data across the architecture.

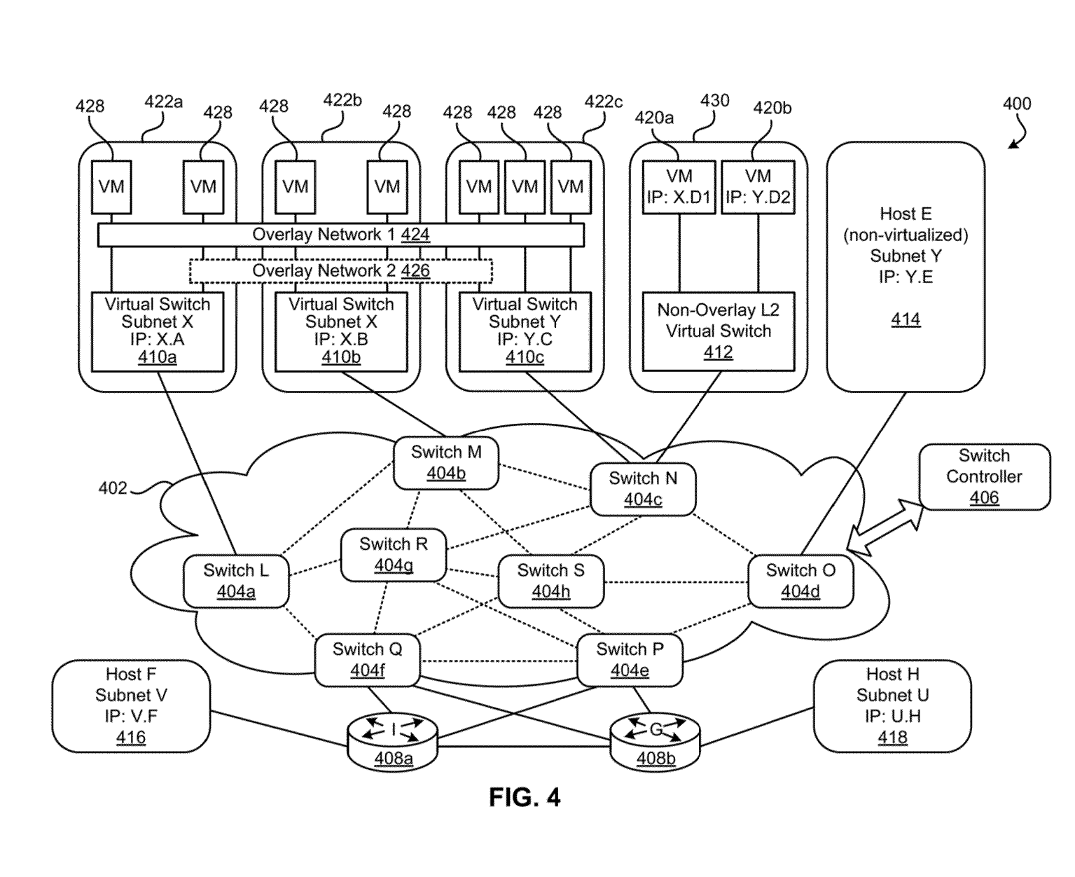

FIG. 4 shows a simplified topological diagram of a SDN system 400 or network having a switch cluster 402 operating as a distributed router, according to one embodiment. The switch cluster 402 comprises a plurality of switches 404a, 404b, . . . , 404n, each switch being connected in the cluster. The switches that are explicitly shown (Switch L 404a, Switch M 404b, Switch N 404c, Switch O 404d, Switch P 404e, Switch Q 404f, Switch R 404g, Switch S 404h) are for exemplary purposes only, as more or less switches than those explicitly shown may be present in the switch cluster 402. An L3 aware switch controller 406, such as an SDN controller, is connected to each switch 404a, 404b, . . . , 404n in the switch cluster 402, either directly or via one or more additional connections and/or devices. Additionally, some switches 404a, 404b . . . , 404n are connected to one or more other virtual or physical devices external to the switch cluster 402. For example, Switch L 404a is connected to vSwitch 410a, Switch Q 404f is connected to Router I 408a, Switch N 404c is connected to non-overlay L2 vSwitch 412 and vSwitch 410c, etc. Of course, these connections are for exemplary purposes only, and any arrangement of connections, number of switches in the switch cluster 402, and any other details about the system 400 may be adapted to suit the needs of whichever installation it is to be used in, as would be understood by one of skill in the art.

The system 400 also has several devices outside of the switch cluster 402, such as Host F 416 which is connected to the switch cluster 402 via Router I 408a, Host H 418 which is connected to the switch cluster 402 via Router G 408b, Host E 414 which is connected to the switch cluster 402 via Switch O 404d, etc. Also capable of being connected to the switch cluster 402 is a non-overlay L2 virtual switch 412 that is supported by a physical server 430. This server may also host VMs 420a and 420b, which have their own IP addresses.

Three servers 422a, 422b, 422c are shown hosting a plurality of VMs 428, each server having a virtualization platform or hypervisor (such as Hyper-V, KVM, Virtual Box, VMware Workstation, etc.) which hosts the VMs 428 and a vSwitch 410a, 410b, 410c, respectively. In addition, the hosted VMs 428 on the various servers 422a, 422b, 422c may be included in one or more overlay networks, such as Overlay networks 1 or 2 (424 or 426, respectively). How the VMs 428 are divided amongst the overlay networks is a design consideration that may be chosen upon implementing the system 400 and adjusting according to needs and desires.

The number of various devices (e.g., Router G 408b, server 422a, Host E 414, etc.) connected to the switch cluster 402 are for exemplary purposes only, and not limiting on the number of devices which may be connected to a switch cluster 402.

Each device in the system 400, whether implemented as a physical or a virtual device, and regardless of whether it is implemented in hardware, software, or a combination thereof, is described as having an internet protocol (IP) address. Due to limited space, the routers 408a, 408b do not have their IP addresses or subnet information shown. However, Router I 408a is in Subnet W, and has a router address of W.I, while Router G 408b is in Subnet Z and has a router address of Z.G.

Some of the concepts used herein are now described with reference to FIG. 4. An IP Interface is a logical entity which has an interface to an IP subnet. Typically, an IP interface for a traditional Ethernet router is associated with either a physical interface (port) or a VLAN. In the distributed router shown in FIG. 4, an IP interface is associated with a VLAN.

Each of the switches 404a, 404b, . . . , 404n in the switch cluster 402 are capable of understanding commands from and exchanging information with the switch controller 406. In order to implement this arrangement, each switch 404a, 404b, . . . , 404n may adhere to OpenFlow standards/protocol, or some other suitable architecture or protocol known in the art. Furthermore, the switch controller 406 is also capable of communicating according to the selected protocol in order to exchange information with each switch 404a, 404b, . . . , 404n in the switch cluster 402.

The switch cluster 402 may be referred to as an OpenFlow Cluster when it includes a collection of contiguous OpenFlow switches which act as a single entity (as far as L3 connectivity is concerned) with multiple interfaces to external devices.

A direct subnet is a subnet which is directly connected to the switch cluster 402—in other words, it is a subnet on which the switch controller 406 has an IP interface, e.g., subnets X, Y, Z, and W.

An indirect subnet is a subnet which is not directly connected to the switch cluster 402 and is reached via a router 408 external to the switch cluster 402—in other words, it is a subnet on which the switch controller 406 has no IP interface, e.g., subnets U and V.

By using the switch cluster 402 as a distributed router, the cluster interface address is treated as an “anycast” address. An entry switch is responsible for L3 routing, and a virtual router is instantiated for each subnet in the switch controller 406. An instance of this virtual router is logically instantiated on all switches 404a, 404b, . . . , 404n using the switch controller's 406 access (e.g., via OpenFlow) to each switch's L3 forwarding table.

All virtual routers use the same media access control (MAC) address (referred to as VIRT_RTR_MAC). Hence, any address resolution protocol (ARP) request for any gateway address is responded to with the VIRT_RTR_MAC address. Also, on all the switches 404a, 404b, . . . , 404n, a route “flow” is installed for each directly connected subnet and each indirect static or learned route (including a default route—which is a special static route for prefix 0/0).

A directly connected subnet route directs to the switch controller 406. Every individual destination matching these uses a separate host entry. Examples of directly connected routes include subnets X, Y, Z, and W in FIG. 4.

An indirectly connected subnet route directs to a next hop MAC address/port. These indirectly connected subnet routes do not use separate host entries for each destination IP; however, they do use a single L3 Longest Prefix Match (LPM) entry for the entire subnet. Examples of indirectly connected routes include subnet V and the default route in FIG. 4.

Route flows are installed with priority equal to their prefix length such that longest prefix length match rules are always obeyed. Additionally, the route “flows” are programmed into the L3 LPM tables, e.g., the Forwarding Information Base (FIB) of each switch. Accordingly, the FIB may be used to support many more routes than what is available in the ternary content-addressable memory (TCAM) flow tables (for example, 16,000+ routes vs. 750 TCAM flows). However, some devices utilizing legacy switch operating protocols, such as OpenFlow-enabled switches, do not have direct access to the switch L3 FIB via OpenFlow. In this case, the route “flow” may be installed in the current TCAM flow table, with a drawback being the limited TCAM flow table size which does not scale for larger deployments.

On the entry switch, when the first time an L3 packet is received for a directly connected host, the packet is sent to the switch controller 406 for ARP resolution.

After ARP resolution, the switch controller 406 installs a host entry flow on the entry switch for subsequent L3 packets directed to the same host. According to one embodiment, this host entry flow modification may include the following relationships:

Match VLAN=VLAN of the IP interface

Match destination MAC (DMAC)=VIRT_RTR_MAC

Match Dest-IP=Destination IP address

Rewrite VLAN=VLAN of the destination host

Rewrite source MAC (SMAC)=VIRT_RTR_MAC

Rewrite DMAC=MAC of the destination host

Forwarding port=Physical port through which the “Rewrite DMAC” is reachable

Using this flow modification, the L3 host entry is a reactive installation in the sense that it is only installed when an L3 packet is seen for the host. This helps in conserving the number of host entry flows consumed compared to proactive installation on all the switches.

The reactive installation of L3 host entries is similar to that of a traditional non-switch controlled router installing ARP entries into its forwarding cache.

In addition, transformation is programmed in the L3 Host Forwarding Table of the entry switch. However, legacy switches will not have direct access to the switch L3 FIB via the communication protocol, such as a legacy OpenFlow-enabled switch.

When the legacy switch does not have direct access to the switch L3 FIB via the communication protocol, the host “flow” may be installed in the current TCAM flow table. One drawback to this procedure is the limited TCAM flow table size (compared to L3 host forwarding tables of most switches) and hence will not scale for larger deployments.

On the entry switch, when the first time an L3 packet is seen for an indirect host of route that does not have the next hop ARP resolved, the packet is sent to the controller for ARP resolution. After ARP resolution the controller installs a route “flow” entry on the entry switch for subsequent L3 packets to the same route. According to one embodiment, this route flow modification may include the following relationships:

Match VLAN=VLAN of the IP interface

Match DMAC=VIRT_RTR_MAC

Match Dest-IP=Prefix

Match Dest-IP Mask=Prefix Subnet Mask

Rewrite VLAN=VLAN of the next hop

Rewrite SMAC=VIRT_RTR_MAC

Rewrite DMAC=MAC of the next hop

Forwarding port=Physical Port through which the “Rewrite DMAC” is reachable

As mentioned before, the transformation is programmed in the L3 Route Forwarding Table (FIB) of all the entry switches. However, if a legacy switch does not have access to the L3 FIB, these may be programmed into the communication protocol TCAM based flow table, such as via OpenFlow.

According to one embodiment, a mechanism is provided for optimizing host table management for the SDN switch cluster 402 (such as an OpenFlow Cluster) with L3 distributed router functionality. A L3 host table is managed by the switch controller 406 and possibly by each switch 404a, 404b, . . . 404n in the switch cluster 402. The L3 host table management may comprise applying a policy to all existing entries (entries which are stored in the L3 host table prior to applying the policy) in the L3 host table in order to utilize aging mechanisms, such as least recently used (LRU) aging, aggressive timeouts, and/or local aging in many different combinations or individually. This methodology may be implemented on the L3 host table of the switch controller 406, on each individual switch 404a, 404b, . . . , 404n in the switch cluster 402, or some combination thereof (e.g., some switches may rely on the L3 host table of the switch controller 406 while other switches utilize their own local L3 host tables).

In this way, the number of entries consumed by the directly connected hosts may be minimized, e.g., one or more existing entries in the L3 host table may be removed according to the policy in order to reduce a number of entries in the L3 host table. This reduction in entry consumption may be accomplished using an aging policy, aggressive timeouts, as well as attempts to optimize the aging performance via local aging on the individual switches 404a, 404b, . . . , 404n in the switch cluster 402.

The L3 (forwarding) host table is used for reaching hosts 414, 416, 418, etc., that are directly connected to the switch cluster 402. This L3 host table may grow quite large, or may even exceed a maximum number of entries for the L3 host table, when a plurality of hosts 414, 416, 418, etc., are connected directly to the switch cluster 402. When local L3 host table management is performed on individual switches 404a, 404b, . . . , 404n in the switch cluster 402, the switch controller 406 may send a message to one or more switches to remove one or more entries from a switch's L3 host table, according to one embodiment. In an alternate embodiment, one or more individual switches 404a, 404b, . . . , 404n in the switch cluster 402 may be configured to management their own L3 host table, thereby obviating the need for a message to be sent from the switch controller 406 to the switch. In yet another embodiment, even when switches are managing their own local L3 host tables, the switch controller 406 may still be able to demand table management through some messaging methodology.

The switch controller 406 and/or each individual switch 404a, 404b, . . . , 404n in the switch cluster 402 may be configured to create a new entry in the L3 host table, the new entry describing a host recently connected to one or more switches in the switch cluster 402. Furthermore, the new entry may be stored in the L3 host table for use in later communications therewith.

To manage the L3 host table (whether on a switch or on the switch controller 406) and keep the number of entries in the L3 host table to a manageable amount, a policy may be employed to manage the L3 host table. In general terms, the policy may be applied to determine whether any existing entries fail one or more predetermined criteria. In one such embodiment, a “least recently used” (LRU) policy may be employed which removes and/or ages out entries which are not being frequently used. Other policies are also possible, such as a least frequently used (LFU) policy, a timeout policy, etc.

This removal process may be carried out periodically, in response to an event, or manually. The period may be every second, every 10 seconds, every 30 seconds, every minute, every 5 minutes, every 10 minutes, or according to any other desired time lapse between executing the removal process. In another embodiment, any type of event may trigger the policy to be enacted, such as manual implementation by a user, identification of a new entry to be added to the L3 host table, attempting to add a new entry to the L3 host table, a new host being identified, connection or disconnection of a host from the switch cluster 402, addition or subtraction of a switch from the switch cluster 402, etc.

In addition, the L3 host table may be managed to only hold a certain amount of entries which may be less than a total amount capable of being held. For example, only a percentage of total table storage may be used, such as 50%, 60%, 75%, 90%, etc. In this way, it can be assured that the L3 host table will never be completely filled and the lookup on the L3 host table will proceed faster than in a full L3 host table. Furthermore, the removal process may be executed whenever the L3 host table reaches a certain threshold of capacity, such as 90% full, 80% full, 75% full, etc., to aggressively manage the number of entries therein. Also, the timeout criteria (time period) may be adjusted to account for the amount that the L3 host table is filled.

In one example, there may be several levels requiring more and more stringent or strict timeout periods at each higher level of filled capacity for the L3 host table. In an exemplary embodiment, a L3 host table may timeout an entry that was added or created more than an amount of time ago (existed for more than a period of time), such as 1 day, 10 hours, 5 hours, 1 hour, 30 minutes, 15 minutes, 10 minutes, etc., according to a timeout policy.

In addition, as the L3 host table becomes more filled with entries, the period of time required to timeout an entry may be reduced, such as from 1 hour normally, to 30 minutes for a L3 host table that is 50% filled, then to 15 minutes for a L3 host table that is 75% filled, then to 5 minutes for a L3 host table that is 90% filled. Of course, any number of levels may be used, and the time periods, thresholds, and/or time values may be adjusted to account for other criteria in the switches, L3 switch cluster, network, and/or hosts.

In one such embodiment, the policy may be configured to dynamically adjust according to a ratio of available space to total space in the L3 host table (available space/total space) such that the ratio does not exceed a first ratio threshold, such as 99%, 95%, 90%, 85%, 80%, etc. Furthermore, at least one criterion may be used to determine whether to remove an entry from the L3 host table, the criterion becoming more stringent or strict in response to the ratio exceeding a second ratio threshold which is less than the first ratio threshold. For example, the second ratio threshold may be 80%, 75%, 70%, 50%, etc., or any percentage less than the first ratio threshold. By more strict or stringent, what is meant is that more and more entries will be determined to qualify to be removed from the L3 host table as the criteria becomes more strict.

Additionally, as the L3 host table becomes less filled, the timeout criteria (period of time) may become more and more relaxed, in a reverse scenario. In addition, there may be some initial time delays where the changes do not occur for a certain period of time, or they may occur immediately when the condition is identified.

That is to say, the timeout policy may be configured to shorten the period of time as the L3 host table becomes more full of entries and to lengthen the period of time as the L3 host table becomes less full of entries.

Any policy known in the art may be used for instituting the removal process. The LRU policy has also been mentioned, but in addition to or in place of this policy, other policies may also be used, such as a LFU policy, first-in-first-out (FIFO) policy, last-in-first-out (LIFO) policy, a timeout policy, etc. Of course, other policies not specifically described herein may be used, as would be understood by one of skill in the art.

The LRU policy may rely on a time threshold to determine whether an entry has been used recently, and then all entries which have not been used within that time frame may be removed from the L3 host table. According to various embodiments, the time threshold may be 1 minute, 5 minutes, 5-10 minutes, 10 minutes, 15 minutes, 30 minutes, 1 hour, etc.

The LFU policy may also rely on a frequency threshold to determine whether an entry has been used frequently, and then all entries which have not been used at a rate above the frequency threshold may be removed from the L3 host table. According to various embodiments, the frequency threshold may be a certain number of accesses in a certain time frame, such as accesses per 10 minutes, accesses per 30 minutes, accesses per hour, etc., and the frequency threshold may be a ratio of more than 0 and less than 100, such as 1, 5, 5-10, 10, 15, 30, 50, etc.

The time or frequency thresholds may also be dynamically adjusted according to observable criteria or information relating to the switch cluster 402, such as how much traffic is passed through the switch cluster 402, how often one or more switches are utilized in the switch cluster 402, how often a host sends/receives traffic, etc. Accordingly, using this information, the thresholds may be adjusted to account for differences in individual devices, to account for differences in traffic during certain time periods of the day, week, month, etc., to tune or alter the policies to more effectively manage the L3 host table, etc.

In another embodiment, an amount of time needed to search the L3 host table for an entry corresponding to an address may be used to determine whether or not the number of entries in the L3 host table needs to be reduced. This may be dynamically implemented such that as the search time increases, the criteria used to remove entries becomes more aggressive, and as the time needed to search decreases, the criteria used to remove entries becomes less aggressive. Aggressiveness of policy criteria indicates how likely it is that entries will be removed when the policy is applied, the more aggressive, the more entries will be indicated as requiring removal.

Aggressive timeouts may also be used in conjunction with the LRU policy (or any other policy), in one embodiment. Furthermore, in one embodiment, the LRU policy and the aggressive timeouts may be performed on each individual switch for more efficient aging. This may be accomplished by having special vendor extension instructions added to each switch which instruct the L3 host table flows to be aged locally by the switches, in addition to or separate from the aging performed on the switch controller's L3 host table.

In one embodiment, when the switch controller 406 determines that one or more entries are to be removed from a L3 host table, the switch controller 406 may cause each switch in the switch cluster 402 that is in a path of the host to install the new entry in a L3 host table of each individual switch 404a, 404b, . . . , 404n. The path of the host may be considered to be any switch on an edge of the switch cluster which is directly connected to the host, or may indicate each switch which may receive traffic destined for the host.

Furthermore, even when the entries in each individual switch's L3 host table are aged out (removed due to the policy or timeout exceptions), the same entries on the switch controller 406 do not need to be aged out. Keeping a host table entry on the switch controller 406 enables the switch controller 406 to have this entry available whenever a switch requires the entry to be installed at a later date, without having to recreate the entry through an ARP process, e.g., sending an ARP request to one or more switches and waiting to receive an ARP request with proper port/address information.

That is to say, a switch may be a member of a switch cluster which comprises a plurality of switches, and may be configured communicate with the switch controller via a communication protocol, directly connect to one or more hosts external of the switch cluster, maintain a L3 host table (separate from the L3 host table maintained by the switch controller) configured to store entries comprising address information for the hosts connected directly to the switch, apply a policy to all existing entries in the L3 host table to determine whether any existing entries fail one or more predetermined criteria, and remove one or more existing entries according to the policy in order to reduce a number of entries in the L3 host table.

Furthermore, in some approaches, the switch may be further configured to create a new entry in the L3 host table, the new entry describing a host recently connected to the switch, and store the new entry in the L3 host table.

In another embodiment, the policy may be based on at least one of: removing least frequently used entries from the L3 host table, removing least recently used entries from the L3 host table, and/or removing any existing entries which have existed for more than a period of time. Furthermore, the policy dictates the removal of any existing entries which have existed for more than a period of time, and is further configured to shorten the period of time as the L3 host table becomes more full of entries and to lengthen the period of time as the L3 host table becomes less full of entries.

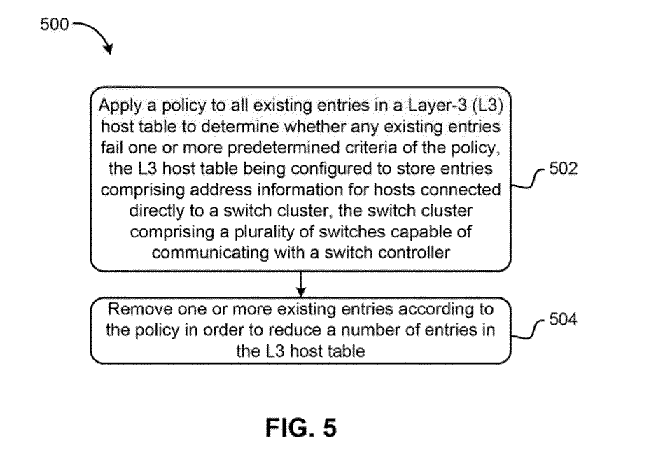

Now referring to FIG. 5, a method 500 for managing a L3 host table is shown according to one embodiment. The method 500 may be performed in accordance with the present invention in any of the environments depicted in FIGS. 1-4, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in one embodiment, the method 500 may be partially or entirely performed by a cluster of switches, one or more vSwitches hosted by one or more servers, a server, a switch, a switch controller (such as a SDN controller, OpenFlow controller, etc.), a processor, e.g., a CPU, an application specific integrated circuit (ASIC), a field programmable gate array (FPGA), etc., one or more network interface cards (NICs), one or more virtual NICs, one or more virtualization platforms, or any other suitable device or component of a network system or cluster.

In operation 502, a policy is applied to all existing entries in a L3 host table to determine whether any existing entries fail one or more predetermined criteria of the policy. The L3 host table is configured to store entries comprising address information for hosts connected directly to a switch cluster, the switch cluster comprising a plurality of switches capable of communicating with a switch controller (via a communication protocol, such as OpenFlow or some other suitable protocol).

In operation 504, one or more existing entries are removed according to the policy in order to reduce a number of entries in the L3 host table. This improves the searchability of the L3 host table and improves response time when searching for an entry therein.

In one embodiment, the method 500 may further include creating a new entry in the L3 host table, the new entry describing a host recently connected to one or more switches in the switch cluster, and storing the new entry in the L3 host table.

In another embodiment, the policy may be based on at least one of: removing least frequently used entries from the L3 host table, removing least recently used entries from the L3 host table, and/or removing any existing entries from the L3 host table which have existed for more than a period of time.

In addition, the policy may comprise dictating the removal of any existing entries from the L3 host table which have existed for more than the period of time. In this case, the method 500 may further comprise shortening the period of time as the L3 host table becomes more full of entries and lengthening the period of time as the L3 host table becomes less full of entries.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A system, comprising:
a switch controller in communication with a plurality of switches in a switch cluster via a communication protocol, at least one switch in the switch cluster being configured to connect to a host,
wherein the switch controller is configured to:
maintain a Layer-3 (L3) host table configured to store entries comprising address information for hosts connected directly to the switch cluster;
apply a policy to all existing entries in the L3 host table; and
remove one or more existing entries according to the policy in order to reduce a number of entries in the L3 host table.

2. The system as recited in claim 1, wherein the switch controller is further configured to:
create a new entry in the L3 host table, the new entry describing a host recently connected to one or more switches in the switch cluster; and
store the new entry in the L3 host table.

3. The system as recited in claim 2, wherein the switch controller is further configured to cause each switch in the switch cluster that is in a path of the host to install the new entry in a L3 host table of each individual switch.

4. The system as recited in claim 1, wherein the policy is applied to determine whether any existing entries fail one or more predetermined criteria.

5. The system as recited in claim 1, wherein the policy is based on removing least frequently used entries and/or least recently used entries from the L3 host table.

6. The system as recited in claim 1, wherein the policy is a timeout policy that removes any existing entries which have existed for more than a period of time.

7. The system as recited in claim 6, wherein the timeout policy is configured to shorten the period of time as the L3 host table becomes more full of entries and to lengthen the period of time as the L3 host table becomes less full of entries.

8. The system as recited in claim 1, wherein the policy is configured to dynamically adjust according to a ratio of available space to total space in the L3 host table such that the ratio does not exceed a first ratio threshold.

9. The system as recited in claim 8, wherein at least one criterion is used to determine whether to remove an entry from the L3 host table, and wherein one or more of the at least one criterion becomes more strict in response to the ratio exceeding a second ratio threshold, the first ratio threshold being greater than the second ratio threshold.

10. The system as recited in claim 1, wherein the switch controller is further configured to apply the policy periodically and/or when an event triggers application of the policy.

11. The system as recited in claim 10, wherein the event is selected from a group consisting of: manual implementation, identification of a new entry to be added to the L3 host table, connection or disconnection of a host from the switch cluster, and addition or subtraction of a switch from the switch cluster.

12. The system as recited in claim 1, wherein the communication protocol is OpenFlow and the switch cluster is a software defined network (SDN).

13. A system, comprising:
a switch, the switch being a member of a switch cluster which comprises a plurality of switches, wherein the switch is configured to:
communicate with a switch controller via a communication protocol;
directly connect to one or more hosts external of the switch cluster,
maintain a Layer-3 (L3) host table configured to store entries comprising address information for the hosts connected directly to the switch;
apply a policy to all existing entries in the L3 host table to determine whether any existing entries fail one or more predetermined criteria; and
remove one or more existing entries according to the policy in order to reduce a number of entries in the L3 host table.

14. The system as recited in claim 13, wherein the switch is further configured to:
create a new entry in the L3 host table, the new entry describing a host recently connected to the switch; and
store the new entry in the L3 host table.

15. The system as recited in claim 13, wherein the policy is based on at least one of: removing least frequently used entries from the L3 host table, removing least recently used entries from the L3 host table, and removing any existing entries which have existed for more than a period of time.

16. The system as recited in claim 15, wherein the policy removes any existing entries which have existed for more than a period of time and is further configured to shorten the period of time as the L3 host table becomes more full of entries and to lengthen the period of time as the L3 host table becomes less full of entries.

17. A method for managing a Layer-3 (L3) host table, the method comprising:
applying a policy to all existing entries in a Layer-3 (L3) host table to determine whether any existing entries fail one or more predetermined criteria of the policy, the L3 host table being configured to store entries comprising address information for hosts connected directly to a switch cluster, the switch cluster comprising a plurality of switches capable of communicating with a switch controller; and
removing one or more existing entries according to the policy in order to reduce a number of entries in the L3 host table.

18. The method as recited in claim 17, further comprising:
creating a new entry in the L3 host table, the new entry describing a host recently connected to one or more switches in the switch cluster; and
storing the new entry in the L3 host table.

19. The method as recited in claim 17, wherein the policy is based on at least one of: removing least frequently used entries from the L3 host table, removing least recently used entries from the L3 host table, and removing any existing entries from the L3 host table which have existed for more than a period of time.

20. The method as recited in claim 19, wherein the policy comprises removing any existing entries from the L3 host table which have existed for more than the period of time, the method further comprising:
shortening the period of time as the L3 host table becomes more full of entries; and
lengthening the period of time as the L3 host table becomes less full of entries.
